(19) United States
(12) Patent Application Publication
(10) Pub. No.: US 2026/0287164 A1
(43) Pub. Date: Sep. 24, 2026

(54) Compact Multi-Purpose Recessed Light Fixture

(71) Applicant: USAI, LLC, New Windsor, NY (US)

(72) Inventors: Jonathan I. Jones, Highland, NY (US); Frank Cogliano, Pomona, NY (US); John M. Reilly, Newburgh, NY (US)

(21) Appl. No.: 19/672,498

(22) Filed: May 8, 2026

Related U.S. Application Data
(63) Continuation of application No. 19/571,440, filed on Mar. 18, 2026.
(60) Provisional application No. 63/773,729, filed on Mar. 18, 2025.

(51) Int. Cl. F21V 29/74; F21V 21/04

(52) U.S. Cl. CPC F21V 29/74; F21V 21/04

(57) ABSTRACT

A recessed light fixture has a lower body assembly and has a lighting module connected to the lower body assembly having a light engine assembly and a heat sink assembly. The heat sink assembly has a first heat sink operable to move relative a second heat sink in a movement range including a first position and a second position. In the first and second positions, the first heat sink being entirely within a vertical profile of the light fixture whereby the light fixture may be installed through an opening in the construction surface when the first heat sink is in any position in the movement range. Alternatively, the first heat sink is entirely within a vertical profile of the light fixture in the first position and extends beyond the profile in the second position.

### FIELD OF THE INVENTION

The invention pertains to lighting, and in particular recessed lighting fixtures.

### BACKGROUND OF THE INVENTION

Recessed lighting fixtures have been a popular lighting solution for many years, providing general illumination for a room without attracting attention to themselves. However, with the rise of interior design as a prominent aspect of home and office improvement, the desire for aesthetically pleasing and functional recessed lighting fixtures has increased.

One challenge that has arisen with the installation of recessed lighting fixtures is the limited space available in ceilings and plenums. Many desired installation locations for recessed lighting have limited space between the ceiling material and the roof or floor above, which can make the installation of traditional recessed lighting fixtures difficult or even impossible. In response to this challenge, there has been a growing demand for low-profile recessed lighting fixtures that can be installed in limited spaces.

In addition to the need for low-profile fixtures, the ability to adjust between a downlight configuration and a wall wash configuration has become highly desirable, as it allows for a variety of lighting effects to be achieved with a single fixture. This adjustability feature can enhance the functionality of the fixture and provide greater flexibility in achieving the desired lighting effects.

Furthermore, serviceability has become an important aspect of recessed lighting fixture design. Traditional fixtures require professional assistance to replace or repair electrical components, which can be time-consuming and costly. The ability to service the fixture from within the room can greatly simplify maintenance and save time and money.

Therefore, what is desired is a recessed lighting fixture that allows for greater flexibility in installation, making it possible to add recessed lighting to spaces that were previously inaccessible, in addition to adjustability between a downlight configuration and a wall wash configuration that allows for a range of lighting effects to be achieved with a single fixture, reducing the need for multiple fixtures to achieve different lighting effects. This can simplify installation and reduce costs. Furthermore, what is desired is the ability to service the fixture from within the room to greatly simplify maintenance, reducing the need for professional assistance and saving time and money.

### SUMMARY OF THE INVENTION

In a first embodiment of the invention, a recessed light fixture is adapted to be installed in a construction surface and to emit light through an opening in the construction surface into a room. The light fixture has three axes consisting of a longitudinal (X) axis, a lateral (Y) axis and a vertical (Z) axis, which are mutually perpendicular.

A lower body assembly is operable to mount the light fixture to the construction surface, and the lower body assembly has an aperture.

A center axis of the light fixture is parallel to the vertical axis (Z) and passes through a center of the aperture at a perpendicular angle.

The lower body assembly has a liner portion configured to at least partially line the opening in the construction surface and the liner portion defines a vertical profile of the light fixture parallel to the vertical (Z) axis.

A lighting module is connected to the lower body assembly and includes a heat sink assembly and a light engine assembly which has a light emitting element.

The heat sink assembly includes first and second heat sinks. The first heat sink is operable to move relative the second heat sink in a movement range including a first and second positions, and the first heat sink maintains a thermal connection pressure with the second heat sink throughout the movement range.

The light engine assembly is mounted to the first heat sink and has an optical axis passing through the aperture.

In the first position of the first heat sink, the optical axis of the light engine assembly is substantially aligned with the center axis and substantially passes through a center of the aperture.

In the second position, the first heat sink is substantially displaced from the first position at least laterally parallel to the longitudinal (X) axis.

The light engine assembly is operable to emit light through the aperture throughout the movement range.

The first and second positions being limit positions and in the first and second positions, the first heat sink is entirely within the vertical profile of the light fixture. Thus, the light fixture may be installed through the opening in the construction surface when the first heat sink is in any position in the movement range.

In a second embodiment, the light fixture, which is adapted to be installed in a construction surface and to emit light through an opening in the construction surface into a room, has a lower body assembly having a liner portion configured to at least partially line the opening in the construction surface and the liner portion defining a vertical profile of the light fixture parallel to the vertical (Z) axis.

A lighting module is connected to the lower body assembly and has a heat sink assembly and a light engine assembly.

The heat sink assembly includes a first heat sink operable to move relative to a second heat sink in a movement range including a first position and a second position, where the first heat sink maintains a thermal connection pressure with the second heat sink throughout the movement range.

In the first position of the first heat sink, the optical axis of the light engine assembly being substantially aligned with a center axis and substantially passing through a center of the aperture.

In the second position, the first heat sink being substantially displaced from the first position at least laterally parallel to the longitudinal (X) axis.

In the first position, the first heat sink being entirely within the vertical profile of the light fixture; and in the second position, the first heat sink extending substantially outside the vertical profile of the light fixture.

In a third embodiment, a recessed light fixture adapted to be installed in a construction surface and to emit light through an opening in the construction surface into a room.

The light fixture has a lower body assembly operable to mount the light fixture to the construction surface. The lower body assembly has a liner portion configured to at least partially line the opening in the construction surface and the liner portion defines a vertical profile of the light fixture parallel to the vertical (Z) axis.

A lighting module is connected to the lower body assembly and includes a light engine assembly and a heat sink assembly including first and second heat sinks.

The second heat sink is movable relative to the first heat sink between a retracted and extended positions.

In the extended position, a thermal interface of the first heat sink is in thermal connection to a thermal interface of the second heat sink, and the second heat sink extends substantially outside the vertical profile of the light fixture.

In the retracted position, the thermal interface of the first heat sink is thermally disconnected from the thermal interface of the second heat sink, and the second heat sink is entirely within the vertical profile of the light fixture.

### BRIEF DESCRIPTION OF THE DRAWINGS

FIG. 1 is a perspective view of the back of a first embodiment of a lighting fixture constructed in accordance with the invention, shown in a downlight position.

FIG. 2 is a perspective view of the front of the lighting fixture of FIG. 1.

FIG. 3 is an elevation view of the front of the lighting fixture of FIG. 1.

FIG. 4 is an elevation view of the back of the lighting fixture of FIG. 1.

FIG. 5 is an elevation view of the right side of the lighting fixture of FIG. 1.

FIG. 6 is an elevation view of the left side of the lighting fixture of FIG. 1.

FIG. 7 is view of the bottom of the lighting fixture of FIG. 1.

FIG. 8 is a view of the bottom of the lighting fixture of FIG. 1, showing the position controls.

FIG. 9 is a plan view of the top of the lighting fixture of FIG. 1.

FIG. 10 is cross-section view of the lighting fixture of FIG. 1, taken along line A-A of FIG. 9.

FIG. 11 is cross-section view of the lighting fixture of FIG. 1 installed in a construction surface.

FIG. 12 is a perspective view of the first embodiment of the lighting fixture, shown in a wall-wash position.

FIG. 13 is an elevation view of the front of the lighting fixture of FIG. 12.

FIG. 14 is an elevation view of the back of the lighting fixture of FIG. 12.

FIG. 15 is an elevation view of the right side of the lighting fixture of FIG. 12.

FIG. 16 is an elevation view of the left side of the lighting fixture of FIG. 12.

FIG. 17 is view of the bottom of the lighting fixture of FIG. 12.

FIG. 18 is a plan view of the top of the lighting fixture of FIG. 12.

FIG. 19 is cross-section view of the lighting fixture of FIG. 12, taken along line B-B of FIG. 18.

FIG. 20 is cross-section view of the lighting fixture of FIG. 12 installed in a construction surface.

FIG. 21 is a perspective view a second embodiment of a lighting fixture constructed in accordance with the invention, shown in a downlight position.

FIG. 22 is an elevation view of the front of the lighting fixture of FIG. 21.

FIG. 23 is an elevation view of the back of the lighting fixture of FIG. 21.

FIG. 24 is an elevation view of the right side of the lighting fixture of FIG. 21.

FIG. 25 is an elevation view of the left side of the lighting fixture of FIG. 21.

FIG. 26 is view of the bottom of the lighting fixture of FIG. 21.

FIG. 27 is a plan view of the top of the lighting fixture of FIG. 21.

FIG. 28 is cross-section view of the lighting fixture of FIG. 21, taken along line D-D of FIG. 27.

FIG. 29 is cross-section view of the lighting fixture of FIG. 21 installed in a construction surface.

FIG. 30 is a perspective view of the second embodiment of the lighting fixture, shown in a wall-wash position.

FIG. 31 is an elevation view of the front of the lighting fixture of FIG. 30.

FIG. 32 is an elevation view of the back of the lighting fixture of FIG. 30.

FIG. 33 is an elevation view of the right side of the lighting fixture of FIG. 30.

FIG. 34 is an elevation view of the left side of the lighting fixture of FIG. 30.

FIG. 35 is view of the bottom of the lighting fixture of FIG. 30.

FIG. 36 is a plan view of the top of the lighting fixture of FIG. 30.

FIG. 37 is cross-section view of the lighting fixture of FIG. 30, taken along line E-E of FIG. 36.

FIG. 38 is cross-section view of the lighting fixture of FIG. 30 installed in a construction surface.

FIG. 39 is a perspective view a third embodiment of a lighting fixture constructed in accordance with the invention, showing the moveable heat sink in a retracted position.

FIG. 40 is an elevation view of the front of the lighting fixture of FIG. 39.

FIG. 41 is an elevation view of the back of the lighting fixture of FIG. 39.

FIG. 42 is an elevation view of the right side of the lighting fixture of FIG. 39.

FIG. 43 is an elevation view of the left side of the lighting fixture of FIG. 39.

FIG. 44 is view of the bottom of the lighting fixture of FIG. 39.

FIG. 45 is a plan view of the top of the lighting fixture of FIG. 39.

FIG. 46 is a perspective view of the third embodiment of the lighting fixture, showing the moveable heat sink in an extended position.

FIG. 47 is an elevation view of the front of the lighting fixture of FIG. 46.

FIG. 48 is an elevation view of the back of the lighting fixture of FIG. 46.

FIG. 49 is an elevation view of the right side of the lighting fixture of FIG. 46.

FIG. 50 is an elevation view of the left side of the lighting fixture of FIG. 46.

FIG. 51 is view of the bottom of the lighting fixture of FIG. 46.

FIG. 52 is a plan view of the top of the lighting fixture of FIG. 46.

FIG. 53 is a bottom view of a fourth embodiment of a lighting fixture constructed in accordance with the invention.

FIG. 54 is an elevation view of the front of the lighting fixture of FIG. 53.

FIG. 55 is a plan view of the top the lighting fixture of FIG. 53.

FIG. 56 is an elevation view of the side of the lighting fixture of FIG. 53.

FIG. 57 is a close-up view of a lighting unit of the lighting fixture of FIG. 53.

FIG. 58 is a cross-section view of the lighting unit of FIG. 57, taken along line G-G.

### DETAILED DESCRIPTION OF THE PREFERRED EMBODIMENTS

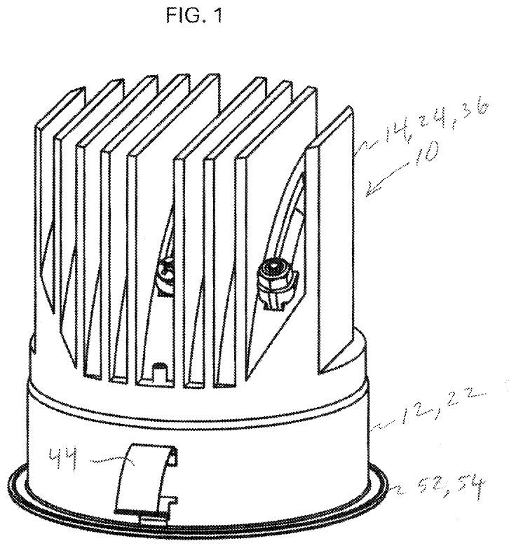

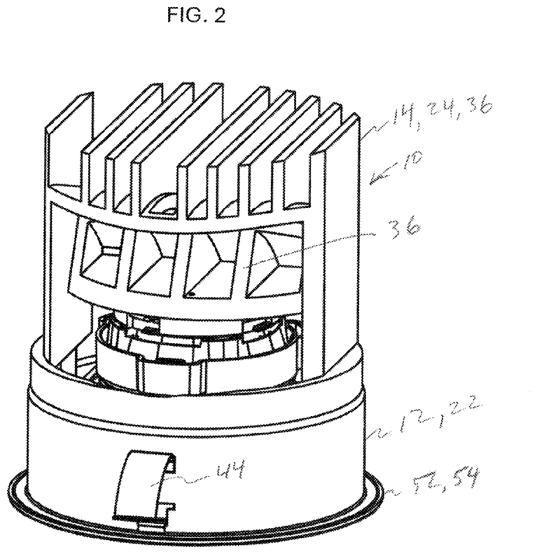

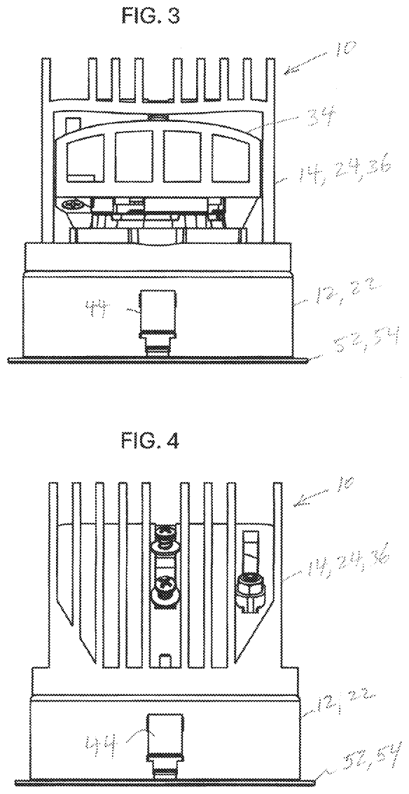

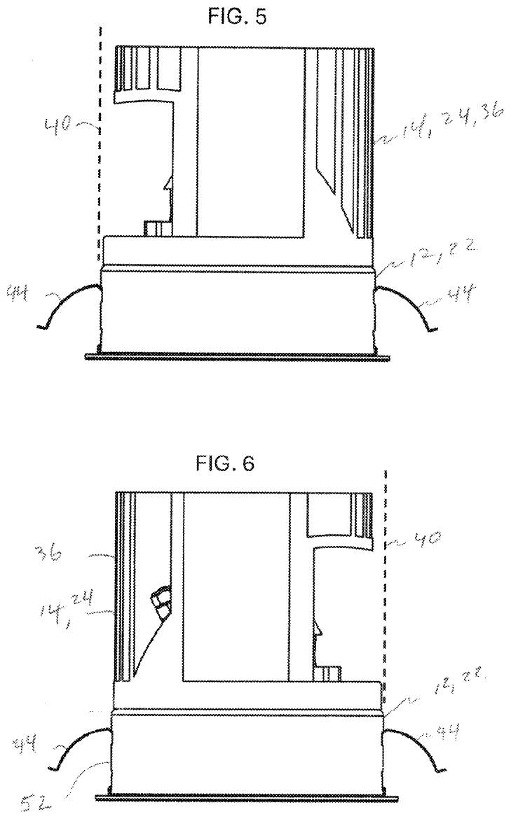

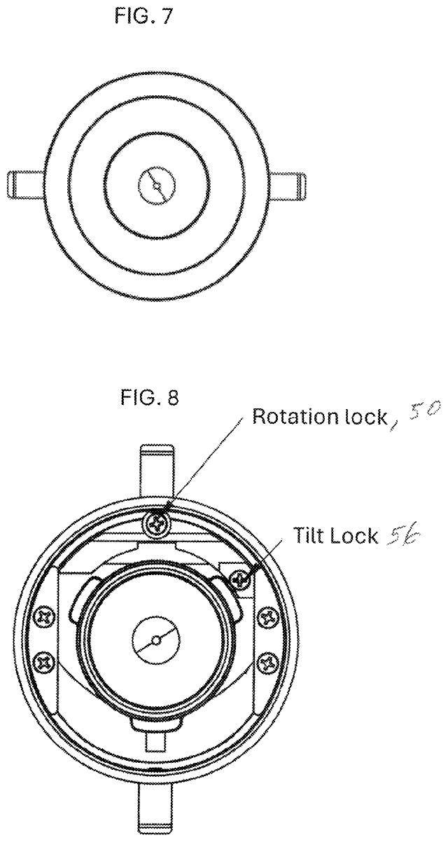

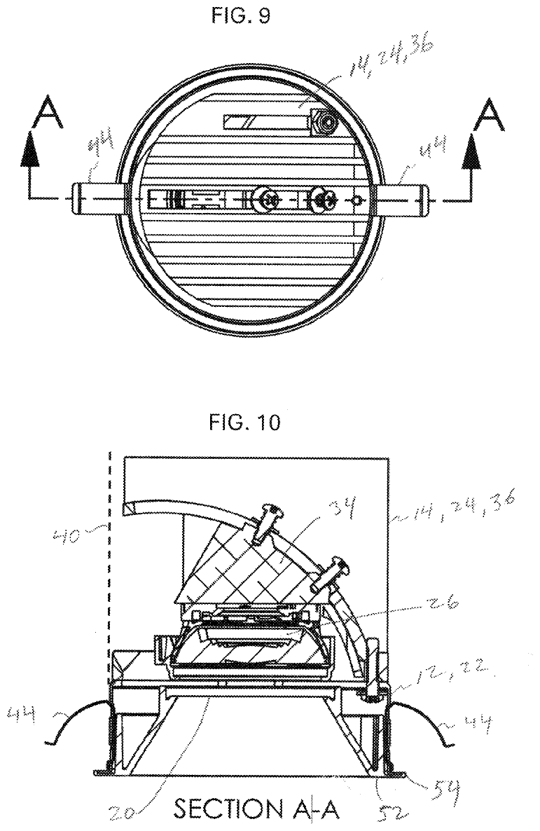

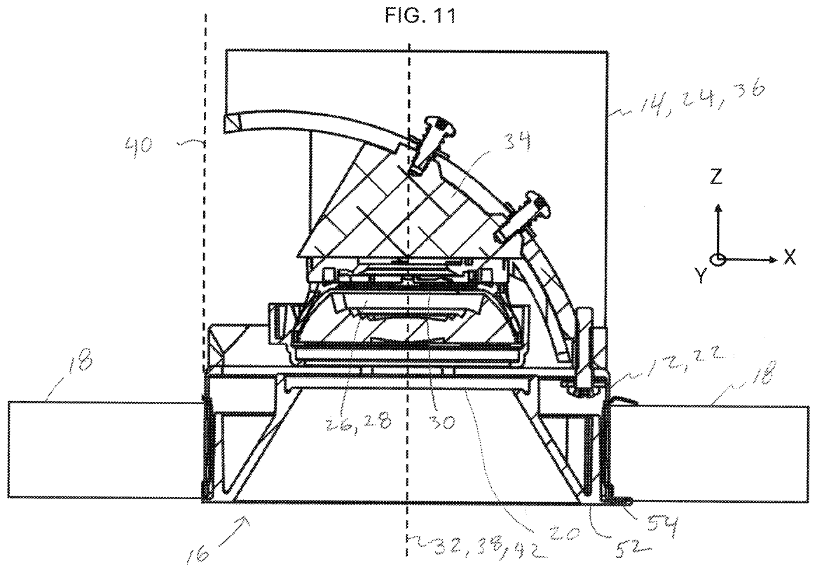

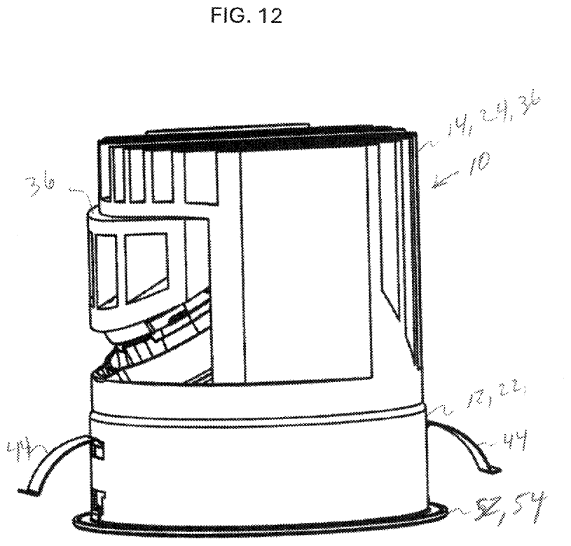

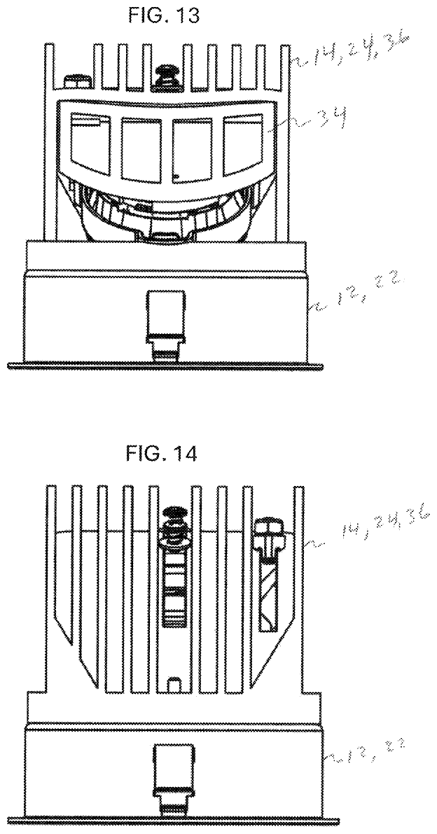

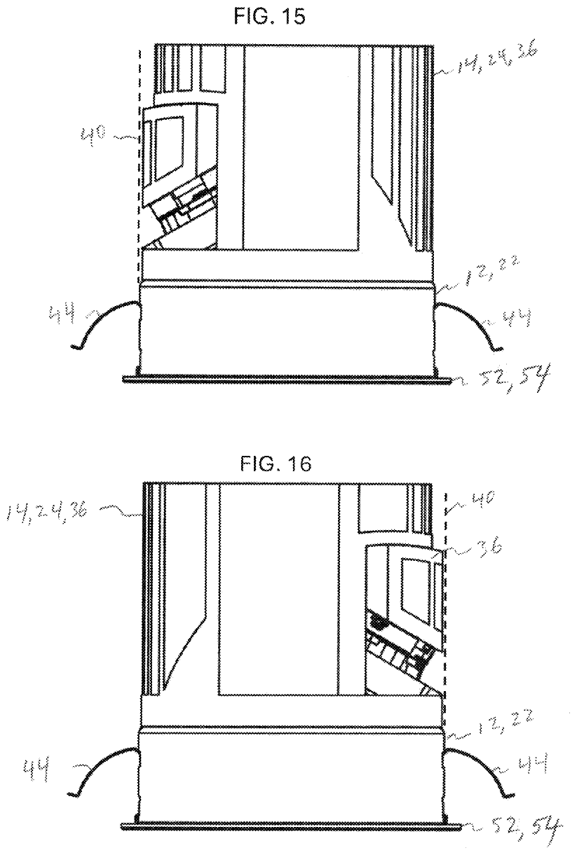

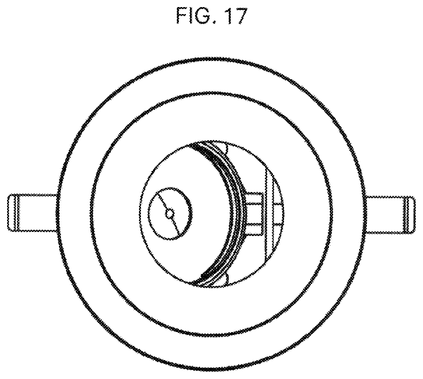

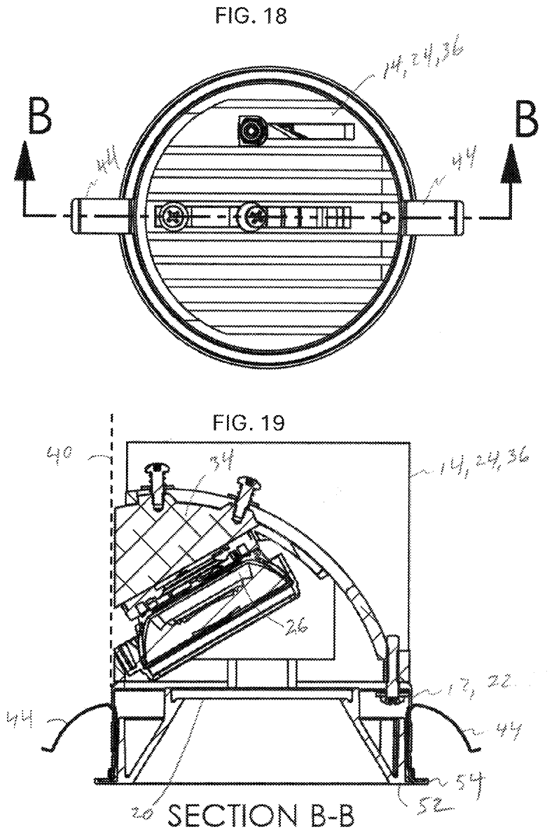

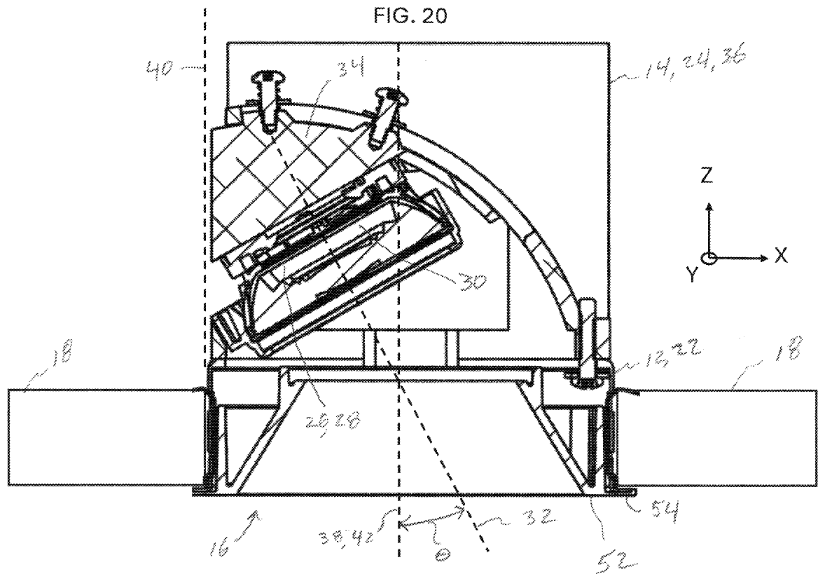

Referring to FIGS. 1-20, in a first embodiment, the lighting fixture 10 can be configured as a recessed lighting fixture for installation in or above a construction surface 18 such as a ceiling, wall or floor, or another suitable construction surface. The lighting fixture 10 projects light through an opening 16 in the construction surface 18 into a room.

Alternatively, the lighting fixture 10 can be configured as a surface mount fixture adapted to mount to or below a construction surface.

The lighting fixture 10 has a lower body assembly 12 and a lighting module 14 connected to the lower body assembly 12.

The lower body assembly 12 is preferably adapted and operable to mount the lighting fixture 10 within the opening 16 of the construction surface 18, where the opening 16 is preferably of a predetermined size and shape. For example, the opening 16 can be a round hole having a diameter of about 0.5 inches or greater, and the lower body assembly 12 can have a complementary exterior shape, such as a generally cylindrical shape sized to be received within the opening 16. Alternatively, the opening 16 can have another shape such as square, rectangular, polygon, or another suitable shape.

The lower body assembly 12 can include a plurality of mounting arms 44 which engage an interior surface of the opening 16 in the construction surface 18 and/or an upper surface 48 of the construction surface 18, to mount the lighting fixture 10. For example, the mounting arms 44 can be flexible wings, or moveable clamps or other suitable mounting structure.

The lighting fixture 10 has three axes including a longitudinal (X) axis, a lateral (Y) axis and a vertical (Z) axis, which are mutually perpendicular.

As an example, when installed in a horizontal ceiling construction surface, the vertical (Z) axis will be aligned vertically, perpendicular to the ceiling, and the longitudinal (X) axis and lateral (Y) axis will be horizontal, parallel to the ceiling. However, other installation locations and orientation angles are within the scope of the invention.

The lower body assembly 12 has an aperture 20 through which light emitted by the lighting module 14 passes.

The lighting fixture 10 has a center axis 38 which is parallel to the vertical (Z) axis and passes through the aperture 20 at a perpendicular angle. The center axis 38 is not necessarily aligned with a center of the lighting fixture 10 but is preferably aligned with a center of the aperture 20 of the lower body assembly 12.

The lower body assembly 12 has a liner portion 22 which can be an integral portion or separate portion and which is adapted to fully or partially line the opening 16 in the construction surface 18, preferably closely such as within 0.25 in to 0.5 in (or more or less), or with in 0-20% (or more or less) of the width of the opening 16. The liner portion defines a vertical profile 40 of the lighting fixture 10 extending vertically upwardly from the periphery of the liner portion, which profile is configured to be closely received within the opening 16 of the construction surface 18. For example, the vertical profile 40 can be sized and/or shaped to be within about 0.25 in to 0.5 in (or less or more), or within 0-20% (or less or more) of the width of the opening 16.

The lower body assembly 12 can include a trim element 52, which for example can be mounted within the liner portion 22. The trim element 52 can include a flange 54 extending outwardly (e.g., radially outwardly) and configured to contact a lower surface of the construction surface 18, for example to cover a gap between liner portion 22 and the edge of the opening 16 in the construction surface 16. Alternatively, the flange 54 and/or trim element 52 can be configured to not contact the construction surface 18, for example, so as to provide an elevated or suspended aesthetic look to the room side, including mounting of other decorative elements.

### The Lighting Module 14 Includes a Heat Sink Assembly 24 and a Light

engine assembly 26.

The heat sink assembly 24 includes first and second heat sinks 34, 36 which comprise or consist of material having high thermal conductivity such as metal, or other suitable material or materials.

The first heat sink 34 is movably mounted to the second heat sink 36 and the first heat sink 34 is operable to move relative to the second heat sink 36 in a movement range between and including a first position and a second position. The first position and/or the second position of the first heat sink 34 are preferably limit positions.

Preferably, the first heat sink 34 is operable to be moved by a user between the first and second positions through the aperture 20 when the lighting fixture 10 is installed in the construction surface 18, for example manually and/or with a tool.

The light engine assembly 26 includes a light emitting element 28, such as one or more LEDs, quantum dots, micro LEDs, laser LEDs, or other suitable light emitting components. The light engine assembly 26 can include a substrate 30 to which the light emitting element 28 is mounted. The light engine assembly 26 is configured to emit light through the aperture 20 and has an optical axis 32 which passes through the aperture.

The light engine assembly 26 is mounted to (and moves with) the first heat sink 34.

In the first position of the first heat sink 34 (FIGS. 1-11), the optical axis 32 of the light engine assembly 26 is colinear, or substantially aligned, with the center axis 38 such that the optical axis 32 and substantially passing through a center of the aperture.

In the second position (FIGS. 12-20), the first heat sink 34 is substantially displaced from the first position at least laterally parallel to the longitudinal (X) axis. As depicted, in the second position, the first heat sink 34 can also be displaced vertically, parallel to the vertical (Z) axis relative to the first position, for example in a direction away from the lower body assembly 12 and the construction surface18.

In additional or alternatively, in the second position, the first heat sink 34 can be tilted relative to the first position, for example about a pivot axis parallel to the lateral (Y) axis. For example, in the second position, the optical axis 32 of the light engine assembly 26 can be aligned at a substantially tilted angle (Θ) relative the center axis 38.

For example, the first position can be a “down-light” or zero-tilt position (e.g., FIGS. 1-11), where most of the light emitted is substantially vertically downward (e.g., parallel to the center axis 38). The second position can be a “wall-wash” position (e.g., FIGS. 12-20), where the light is emitted at substantial angle from vertical, and typically toward an adjacent wall or object to be illuminated.

A tilt position of the first heat sink 34 and light engine assembly attached 26 attached thereto is preferably adjustable relative to the second heat sink 36 to a plurality of positions along an adjustment path (or preferably continuously to any position along the path). For example, the adjustment path can follow a curve lying on a (typically vertical) plane perpendicular to the plane of the aperture 20 of the lighting fixture 10 and concave toward the plane of the aperture 20 such that, during movement of the first heat sink 34 along the adjustment path, the optical axis 32 of the engine assembly 26 pivots (tilts) relative to the center axis 38. Alternatively, the adjustment path can have a different shape or shapes such as any combination of curved, linear, angular, or stepped, or other suitable shape(s).

As an example, referring to FIGS. 1-11, the lighting fixture 10 is shown in a “zero tilt” position along the path, wherein the optical axis 32 is co-linear with the center axis 38. In this position, the lighting fixture 10 may be used as a down-light wherein the light emitted from the lighting fixture is directed straight through (perpendicular to) the plane of the aperture 20 of the lighting fixture 10 (e.g., at zero (0) degree tilt). Preferably, the first, “zero” tilt position is a limit position at one end of the adjustment path so that the lighting fixture 10 can be easily and reliably placed in the zero (0) degree tilt position

As a further example, referring to FIGS. 12-20, the lighting fixture 10 is shown in a fully tilted position (e.g., 5 degrees or more, such as 40 degrees or more). The tilt adjustment allows the lighting fixture 10 to change to a wall-wash orientation wherein the light is emitted through the aperture at an angle (Θ) relative to the aperture plane. Preferably, in all (or some) non-zero tilt angles, the optical axis 32 is angularly displaced from, but intersects the center axis 38, at the center of the aperture 20.

The first heat sink 34 is configured to be entirely within the vertical profile 40 of the lighting fixture 10 in all positions in the movement range, including the first and second positions. This configuration allows the lighting fixture 10 to fit through the opening 16 in the construction surface 18 in any tilt position of the first heat sink 34 including the first position (zero-tilt) and the second position (fully tilted), and all positions therebetween. Preferably, the first heat sink 34 is configured such that an outer profile thereof is substantially parallel to the vertical profile 40 when the heat sink is in the second position.

Thus, the lighting fixture 10 can be installed through the opening 16 in the construction surface 18 when the first heat sink 34 is in any position in the movement range.

The lighting module 14 can be configured to rotate relative to the lower body assembly 12, for example at least 5 degrees (e.g., at least 360 degrees), about a rotation axis 42 parallel to, or colinear with, the vertical center axis 38 to allow for aiming of the emitted light.

The lighting fixture 10 can include an over-rotation stop to prevent rotation of the lighting module 14 greater than a predetermined amount relative to the lower body assembly 12, for example more than 5-20 degrees or 360-365 degrees, or another predetermined amount of rotation.

Further, the lighting fixture 10 preferably includes a rotation lock 50 to selectively permit and prevent rotation of the lighting module 14, which lock is preferably accessible through the aperture 20. The lighting fixture 10 an also include a tilt lock 56, which is preferably similarly accessible through the aperture 20.

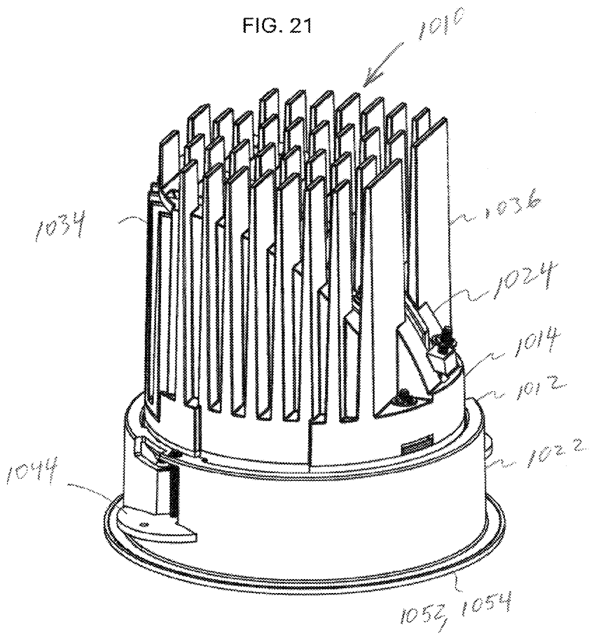

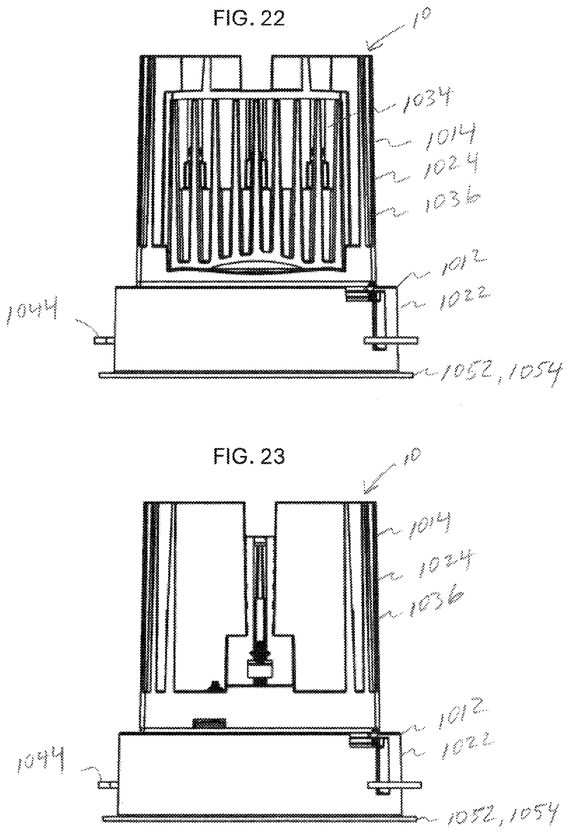

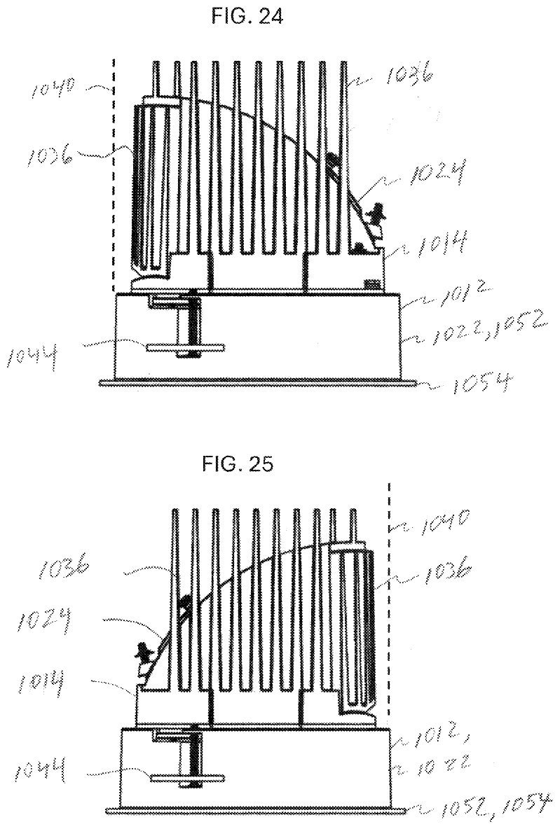

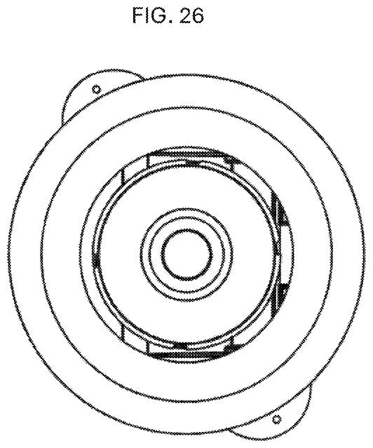

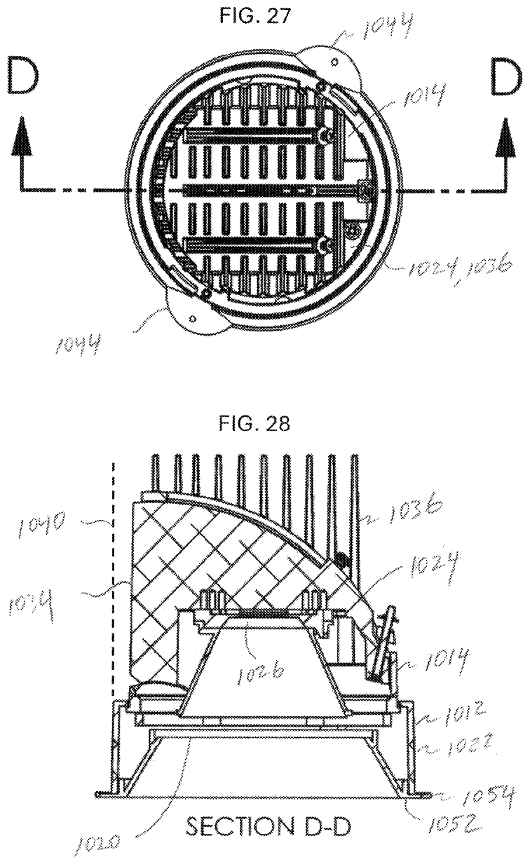

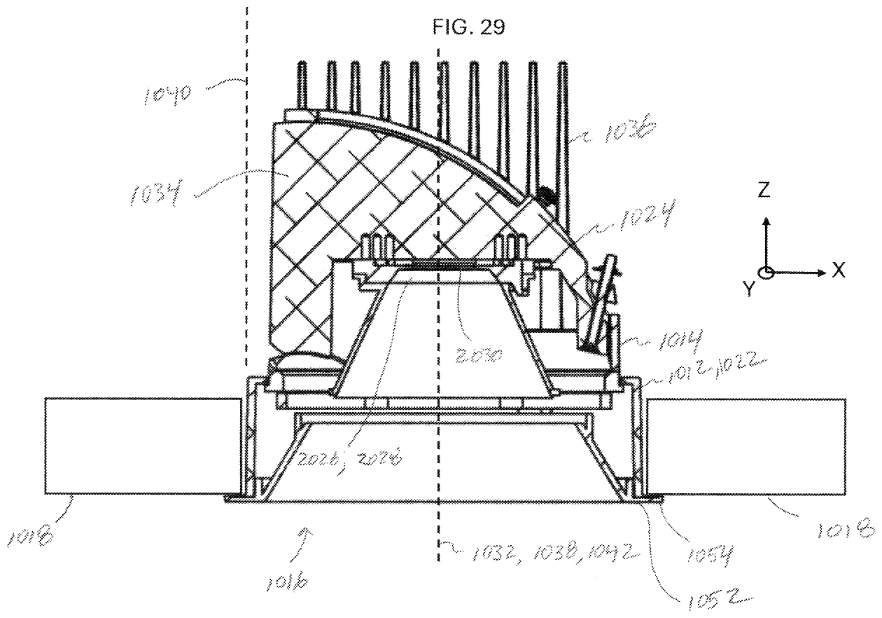

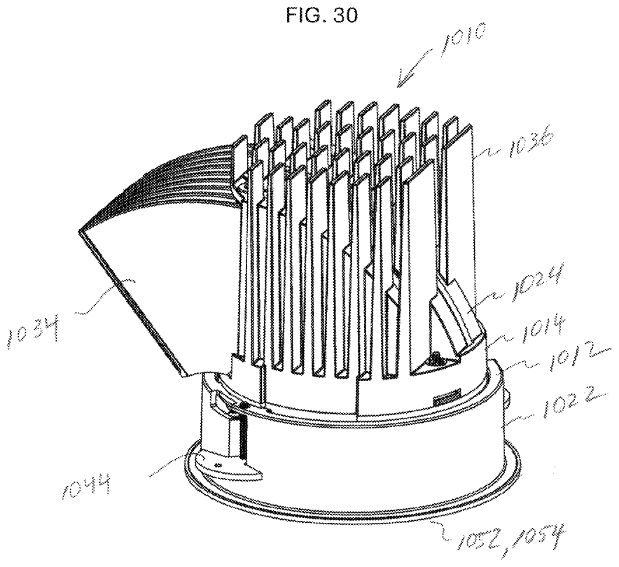

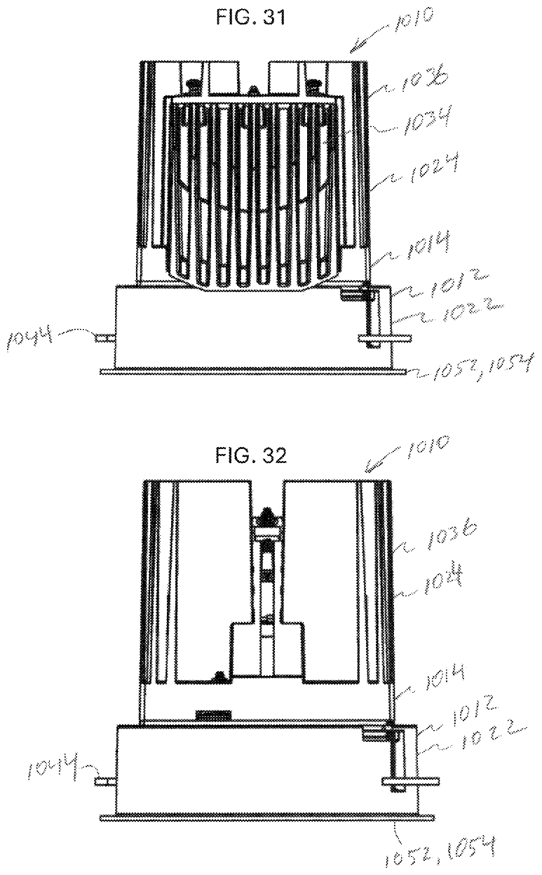

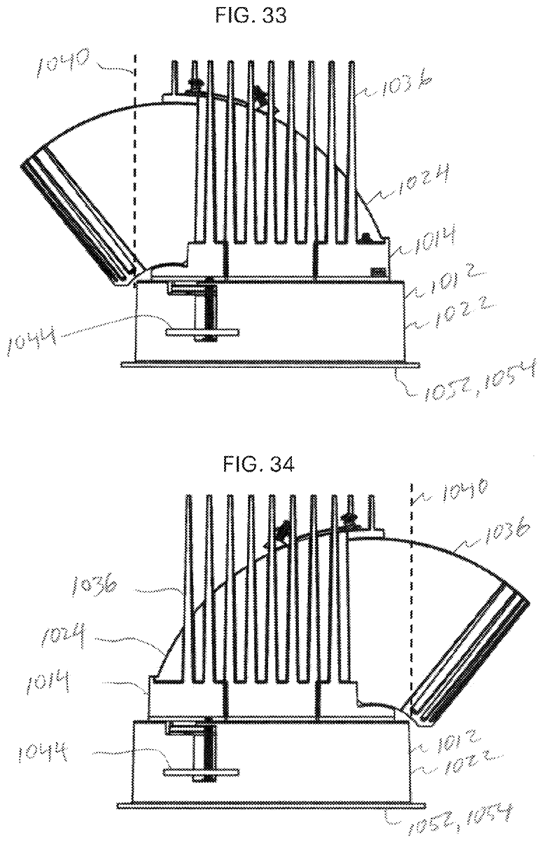

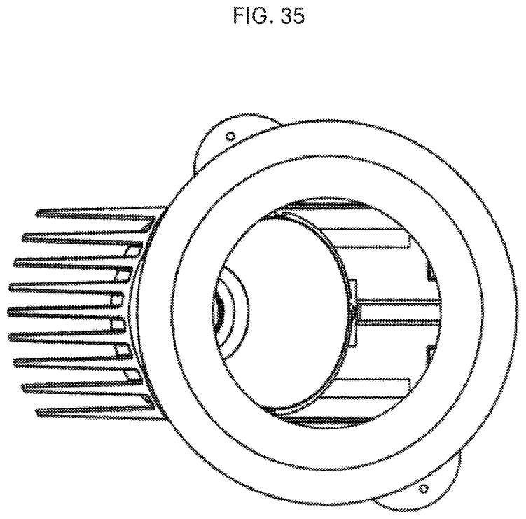

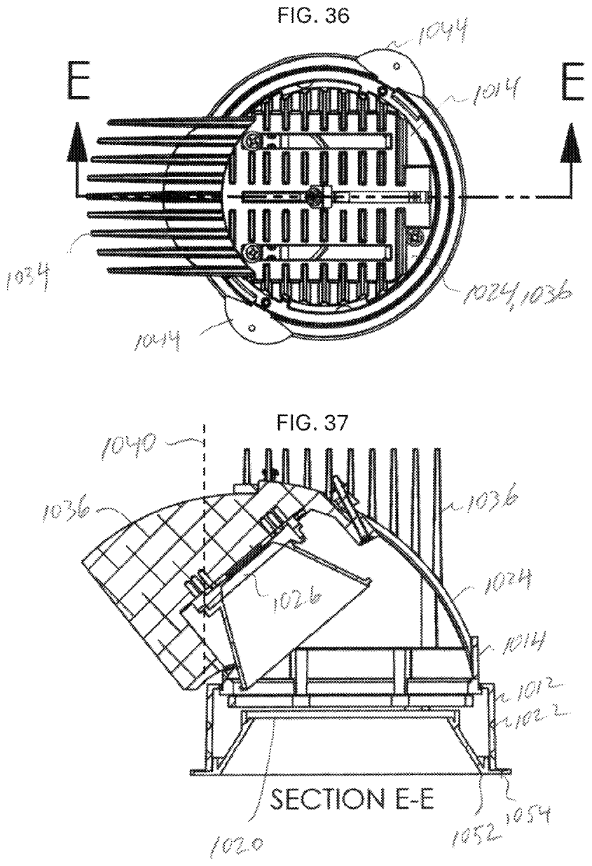

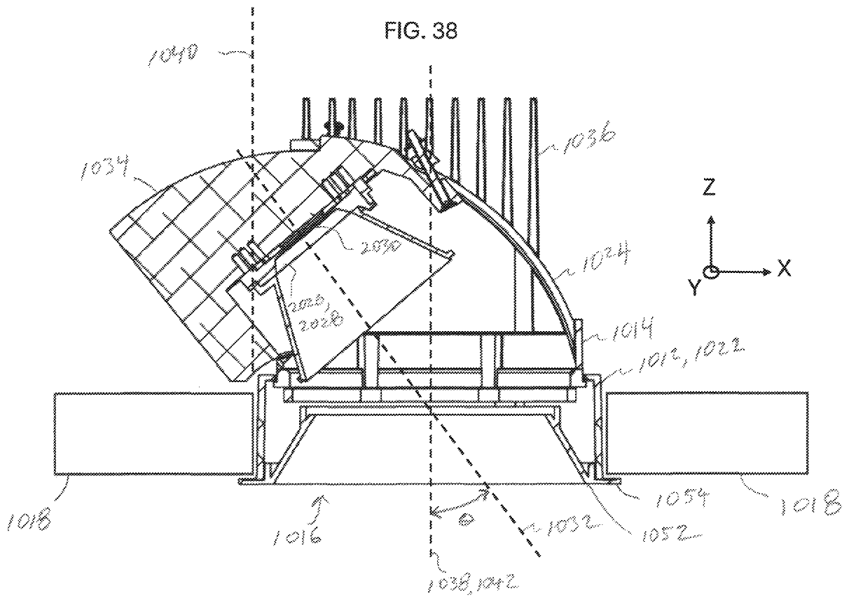

Referring to FIGS. 21-38, in a second embodiment, the lighting fixture 1010 can be configured as described herein but the first heat sink 1034 can be sized such that it extends substantially beyond the vertical profile 1040 of the lighting fixture 1010, when the first heat sink 1034 is in the second (e.g., fully-tilted) position, to provide additional heat sink capacity (e.g., FIGS. 30-38).

Preferably, when in the first (zero-tilt) position (and other non-fully tilted positions), the first heat sink 1034 remains substantially within vertical profile 1040 of the light fixture 10 (see for example, FIGS. 21-29) which also allows the lighting fixture 10 to fit through the prescribed opening 1016 within the construction surface 1018 in such tilt positions. To remove the light fixture 10 from the construction surface 1018, the first heat sink 1034 can be moved out of the second (fully tilted) position into the first (zero-tilt) position or an intermediary tilt position therebetween.

More specifically, in the second embodiment, the lighting fixture 1010 can be configured as a recessed lighting fixture for installation in or above a construction surface 1018 such as a ceiling, wall or floor, or another suitable construction surface. The lighting fixture 1010 projects light through an opening 1016 in the construction surface 1018 in to a room. Alternatively, the lighting fixture 1010 can be configured as a surface mount fixture adapted to mount to or below a construction surface.

The lighting fixture 1010 has a lower body assembly 1012 and a lighting module 1014 connected to the lower body assembly 1012.

The lower body assembly 1012 is preferably adapted and operable to mount the lighting fixture 1010 within the opening 1016 of the construction surface 1018, where the opening 1016 is preferably of a predetermined size and shape. For example, the opening 1016 can be a round hole having a diameter of about 0.5 inches or greater, and the lower body assembly 1012 can have a complementary exterior shape, such as a generally cylindrical shape sized to be received within the opening 1016. Alternatively, the opening 16 can have another shape such as square, rectangular, polygon, or another suitable shape.

The lower body assembly 1012 can include a plurality of mounting arms 1044 which engage an interior surface of the opening 1016 in the construction surface 1018 and/or an upper surface 1048 of the construction surface 1018, to mount the lighting fixture 1010. For example, the mounting arms 1044 can be flexible wings, or moveable clamps or other suitable mounting structure.

The lighting fixture 1010 has three axes including a longitudinal (X) axis, a lateral (Y) axis and a vertical (Z) axis, which are mutually perpendicular.

As an example, when installed in a horizontal ceiling construction surface, the vertical (Z) axis will be aligned vertically, perpendicular to the ceiling, and the longitudinal (X) axis and lateral (Y) axis will be horizontal, parallel to the ceiling. However, other installation locations and orientation angles are within the scope of the invention.

The lower body assembly 1012 has an aperture 1020 through which light emitted by the lighting module 1014 passes.

The lighting fixture 1010 has a center axis 1038 which is parallel to the vertical (Z) axis and passes through the aperture 1020 at a perpendicular angle. The center axis 1038 is not necessarily aligned with a center of the lighting fixture 1010 but is preferably aligned with a center of the aperture 1020 of the lower body assembly 1012.

The lower body assembly 1012 has a liner portion 1022 which can be an integral or separate portion and which is adapted to fully or partially line the opening 1016 in the construction surface 1018, preferably closely such as within 0.25 in to 0.5 in (or less or more), or within 0-20% (or less or more) of the opening width of the opening. The liner portion defines a vertical profile 1040 of the lighting fixture 1010 extending vertically upwardly from the periphery of the liner portion, which profile is configured to be closely received within the opening 1016 of the construction surface 1018. For example, the vertical profile 1040 can be sized and shaped to be within 0.25 in or 0.5 in, or within about 0-20% of the width of the opening 1016.

The lower body assembly 1012 can include a trim element 1052, which for example can be mounted within the liner portion 1022. The trim element 1052 can include a flange 1054 extending radially outwardly and configured to contact a lower surface of the construction surface 1018, for example to cover a gap between liner portion 1022 and the edge of the opening 1016 in the construction surface 1016. Alternatively, the flange 1054 and/or trim element 1052 can be configured to not contact the construction surface 1018, for example, so as to provide an elevated or suspended aesthetic look to the room side, including mounting of other decorative elements.

The lighting module 1014 includes a heat sink assembly 1024 and a light engine assembly 1026.

The heat sink assembly 1024 includes first and second heat sinks 1034, 1036 which comprise or consist of material having high thermal conductivity such as metal, or other suitable material or materials.

The first heat sink 1034 is movably mounted to the second heat sink 1036 and the first heat sink 1034 is operable to move relative to the second heat sink 1036 in a movement range between and including a first position and a second position. The first position and/or the second position of the first heat sink 1034 are preferably limit positions.

Preferably, the first heat sink 1034 is operable to be moved by a user between the first and second positions through the aperture 1020 when the lighting fixture 1010 is installed in the construction surface 1018, for example manually and/or with a tool.

The light engine assembly 1026 includes a light emitting element 1028, such as one or more LEDs, quantum dots, micro LEDs, laser LEDs, or other suitable light emitting components. The light engine assembly can also include a substrate 30 to which the light emitting element 1028 is mounted. The light engine assembly 1026 is configured to emit light through the aperture 1020 and has an optical axis 1032 which passes through the aperture.

The light engine assembly 1026 is mounted to (and moves with) the first heat sink 1034.

In the first position of the first heat sink 1034 (FIGS. 21-29), the optical axis 1032 of the light engine assembly 1026 is colinear, or substantially aligned, with the center axis 1038 such that the optical axis 1032 and substantially passing through a center of the aperture;

In the second position (FIGS. 30-38), the first heat sink 1034 is substantially displaced from the first position at least laterally parallel to the longitudinal (X) axis. As depicted, in the second position, the first heat sink 1034 can also be displaced vertically, parallel to the vertical (Z) axis relative to the first position, for example in a direction away from the lower body assembly 1012 and the construction surface 1018.

In additional or alternatively, in the second position, the first heat sink 1034 can be tilted relative to the first position, for example about a pivot axis parallel to the lateral (Y) axis. For example, in the second position, the optical axis 1032 of the light engine assembly 1026 can be aligned at a substantially tilted angle (Θ) relative the center axis 1038.

For example, the first position can be a “down-light” or zero-tilt position, where most of the light emitted is substantially vertically downward (e.g., parallel to the center axis 1038). The second position can be a “wall-wash” position, where the light is emitted at substantial angle from vertical, and typically toward an adjacent wall or object to be illuminated.

A tilt position of the first heat sink 1034 and light engine assembly attached 1026 attached thereto is preferably adjustable relative to the second heat sink 1036 to a plurality of positions along an adjustment path (or preferably continuously to any position along the path). For example, the adjustment path can follow a curve lying on a (typically vertical) plane perpendicular to the plane of the aperture 1020 of the lighting fixture 10 and concave toward the plane of the aperture 1020 such that, during movement of the first heat sink 1034 along the adjustment path, the optical axis 1032 of the engine assembly 1026 pivots (tilts) relative to the center axis 1038. Alternatively, the adjustment path can have a different shape or shapes such as any combination of curved, linear, angular, or stepped, or other suitable shape(s).

As an example, referring to FIGS. 21-29, the lighting fixture 1010 is shown in a “zero tilt” position along the path, wherein the optical axis 1032 is co-linear with the center axis 1038. In this position, the lighting fixture 1010 may be used as a down-light wherein the light emitted from the lighting fixture is directed straight through (perpendicular to) the plane of the aperture 1020 of the lighting fixture 1010 (e.g., at zero (0) degree tilt). Preferably, the first, “zero” tilt position is a limit position at one end of the adjustment path so that the lighting fixture 1010 can be easily and reliably placed in the zero (0) degree tilt position

As a further example, referring to FIGS. 30-38, the lighting fixture 1010 is shown in a fully tilted position (e.g., 5 degrees or more, such as 40 degrees or more). The tilt adjustment allows the lighting fixture 1010 to change to a wall-wash orientation wherein the light is emitted through the aperture at an angle (Θ) relative to the aperture plane. Preferably, in all (or some) non-zero tilt angles, the optical axis 1032 is angularly displaced from, but intersects the center axis 1038, at the center of the aperture 1020.

The first heat sink 1034 is configured to be entirely within the vertical profile 1040 of the lighting fixture 1010 in the first position, and to extend substantially outside the vertical profile 1040 in the second position. Preferably, the first heat sink 1034 is configured such that an outer profile thereof is substantially parallel to the vertical profile 1040 when the heat sink is in the first position.

This configuration allows the lighting fixture 1010 to be installed or removed from the opening 1016 in the construction surface 1018 at least in the when the first heat sink 1034 is in the first position.

The movement range of the first heat sink 1034 can also include a first range including the first position and a first intermediate position between the first and second positions, and the first heat sink 1034 can be configured to be entirely within the vertical profile 1040 of the lighting fixture 1010 in any position in the first range.

This configuration allows the lighting fixture 1010 to be installed or removed from the opening 1016 in the construction surface 1018 at least when the first heat sink 1034 is in any position in the first range.

The movement range can also include a second range including the first position and a second intermediate position between the first intermediate position and the second position, and the first heat sink 1034 can be configured to allow installation and removal of the lighting fixture 1010 from the opening 1016 in the construction surface 1018 in any position in the second range.

The lighting module 1014 can be configured to rotate relative to the lower body assembly 1012, for example at least 5 degrees (e.g., at least 360 degrees), about a rotation axis 1042 parallel to, or colinear with, the vertical center axis 1038 to allow for aiming of the emitted light.

The lighting fixture 1010 can include an over-rotation stop to prevent rotation of the lighting module 1014 greater than a predetermined amount relative to the lower body assembly 1012, for example more than 5-20 degrees or 360-365 degrees, or another predetermined amount of rotation.

Further, the lighting fixture 1010 preferably includes a rotation lock 1050 to selectively permit and prevent rotation of the lighting module 1014, which lock is preferably accessible through the aperture 1020. The lighting fixture 1010 an also include a tilt lock 1056, which is preferably similarly accessible through the aperture 1020.

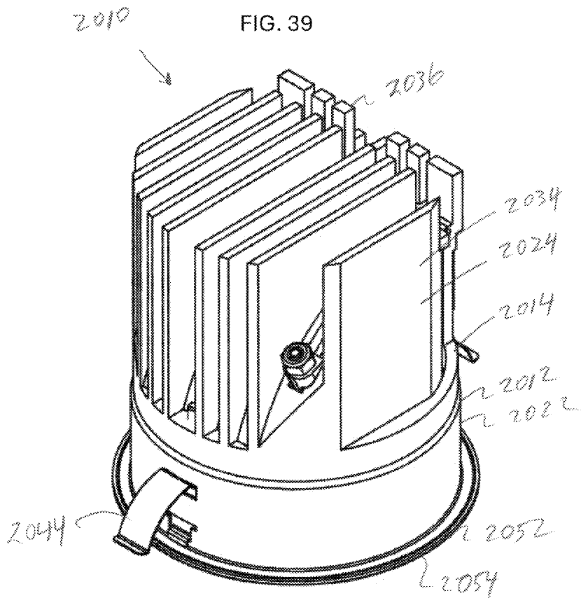

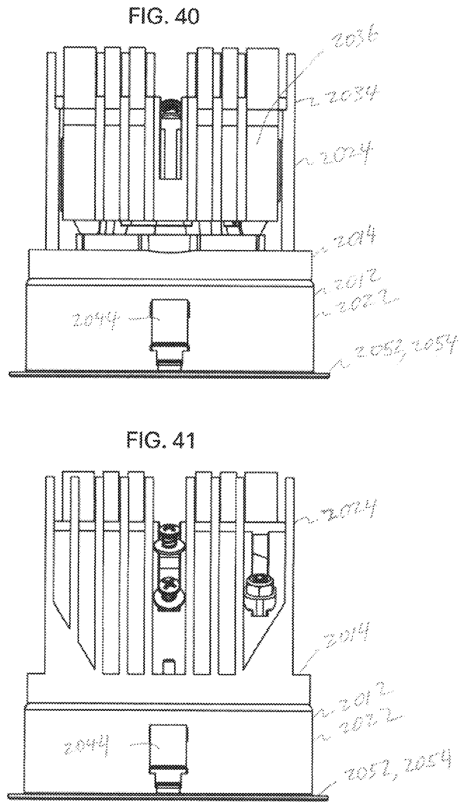

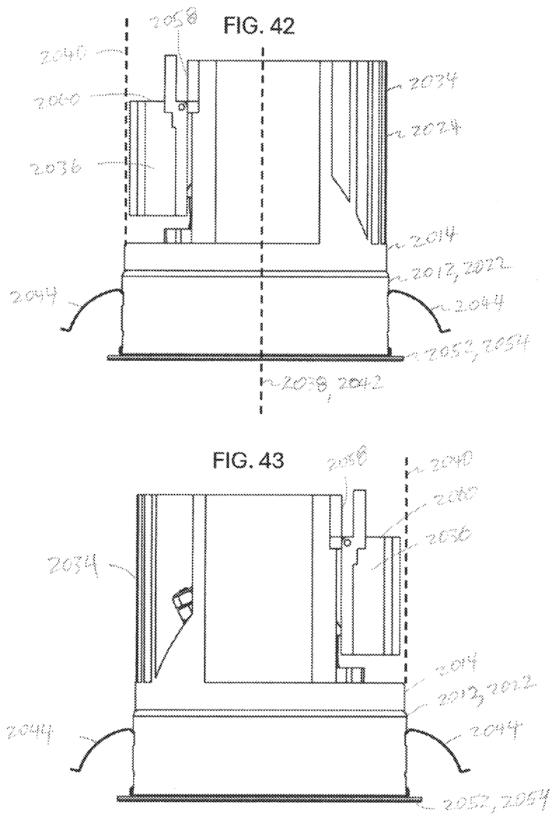

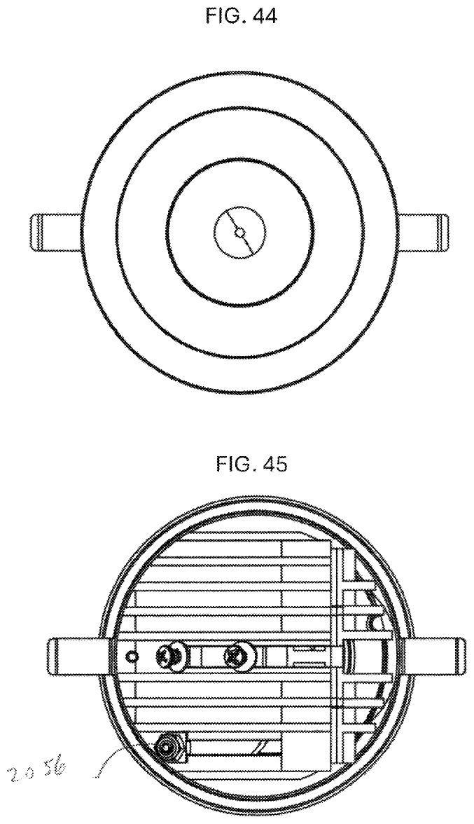

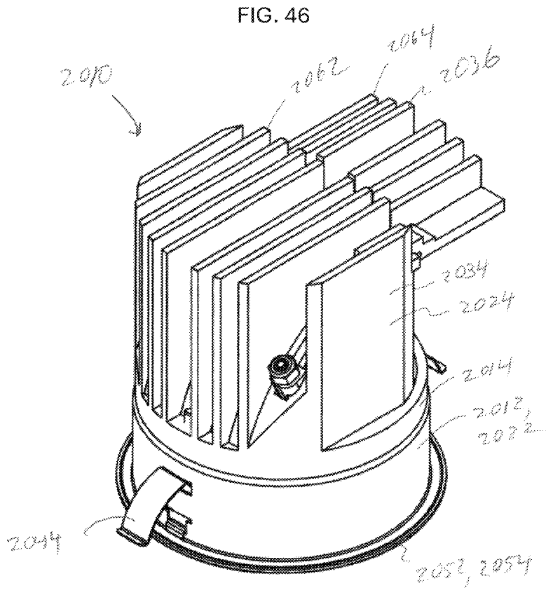

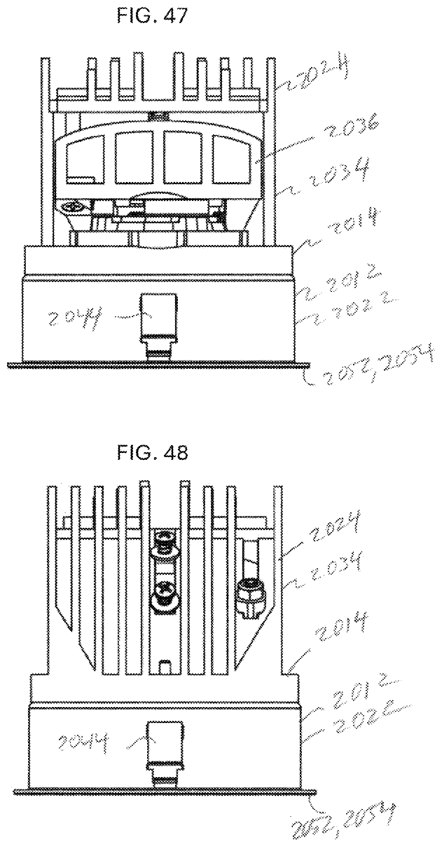

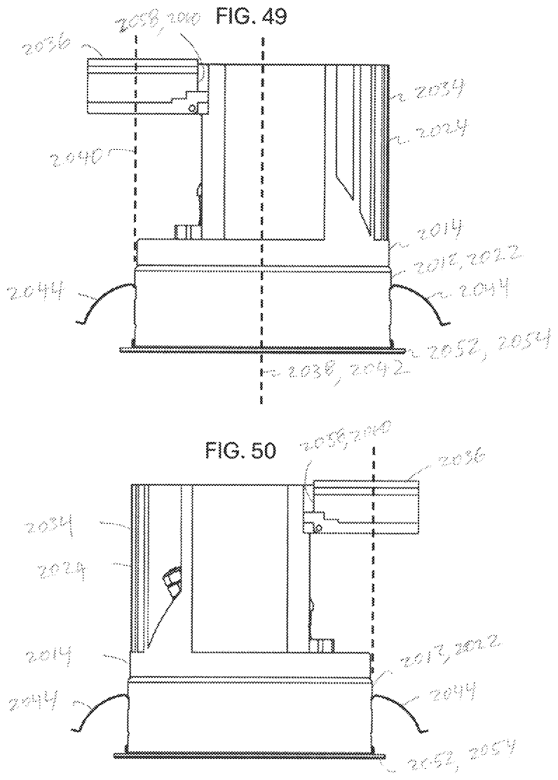

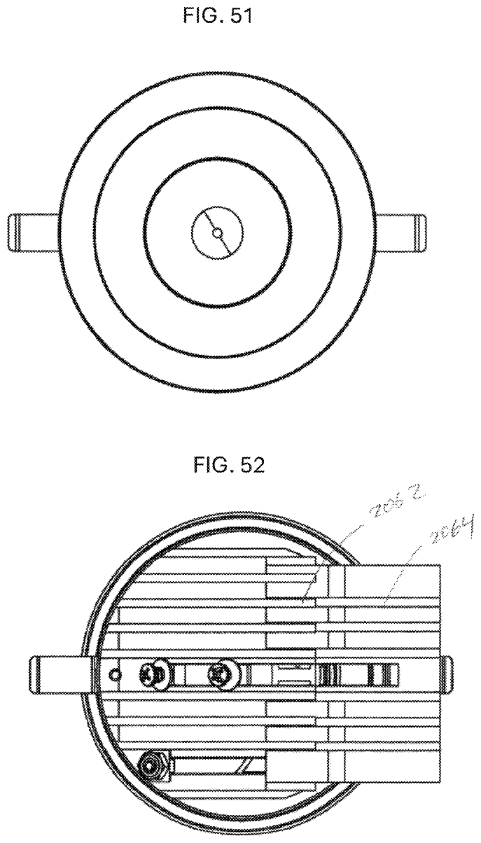

Referring to FIGS. 39-52, in a third embodiment, the lighting fixture 2010 can be configured as described herein but the heatsink assembly 2024 can extend beyond the vertical profile 2040 of the lighting fixture and/or beyond the opening 2016 in the construction surface 2018 after initial installation of the lighting fixture 2010, proving increased heatsink capacity.

For example, the heat sink assembly 2024 can include a movable second heat sink 2036 having a first, retracted, position (See e.g., FIGS. 39-45) in which the second heat sink 2036 is within the vertical profile 2040 of the lighting fixture 2010, and having an extended position (See e.g., FIGS. 46-52) in which the second heat sink 2036 extends outwardly from the vertical profile 2040. The second heat sink 2036 can be pivotally connected to a first heat sink 2034 and can preferably be moved between the retracted and extended positions by manual operation from within an interior of the lighting fixture 2010, from within the room, after installation of the lighting fixture 2010.

More specifically, in the third embodiment, the lighting fixture 2010 can be configured as a recessed lighting fixture for installation in or above a construction surface 2018 such as a ceiling, wall or floor, or another suitable construction surface. The lighting fixture 2010 projects light through an opening 2016 in the construction surface 2018 in to a room. Alternatively, the lighting fixture 2010 can be configured as a surface mount fixture adapted to mount to or below a construction surface.

The lighting fixture 2010 has a lower body assembly 2012 and a lighting module 2014 connected to the lower body assembly 2012. The lighting module 2014 preferably includes a light engine assembly (not shown) having one or more light emitting elements, for example as described herein with respect to the first and/or second embodiments.

The lower body assembly 2012 is preferably adapted and operable to mount the lighting fixture 2010 within the opening 2016 of the construction surface 2018, where the opening 2016 is preferably of a predetermined size and shape. For example, the opening 2016 can be a round hole having a diameter of about 0.5 inches or greater, and the lower body assembly 2012 can have a complementary exterior shape, such as a generally cylindrical shape sized to be received within the opening 2016. Alternatively, the opening 2016 can have another shape such as square, rectangular, polygon, or another suitable shape.

The lower body assembly 2012 can include a plurality of mounting arms 2044 which engage an interior surface of the opening 2016 in the construction surface 2018 and/or an upper surface 2048 of the construction surface 2018, to mount the lighting fixture 2010. For example, the mounting arms 2044 can be flexible wings, or moveable clamps or other suitable mounting structure.

The lighting fixture 2010 has three axes including a longitudinal (X) axis, a lateral (Y) axis and a vertical (Z) axis, which are mutually perpendicular.

As an example, when installed in a horizontal ceiling construction surface, the vertical (Z) axis will be aligned vertically, perpendicular to the ceiling, and the longitudinal (X) axis and lateral (Y) axis will be horizontal, parallel to the ceiling. However, other installation locations and orientation angles are within the scope of the invention.

The lower body assembly 2012 has an aperture 2020 through which light emitted by the lighting module 2014 passes.

The lighting fixture 2010 has a center axis 2038 which is parallel to the vertical (Z) axis and passes through the aperture 2020 at a perpendicular angle. The center axis 2038 is not necessarily aligned with a center of the lighting fixture 2010 but is preferably aligned with a center of the aperture 2020 of the lower body assembly 20 12.

The lower body assembly 2012 has a liner portion 2022 which can be an integral or separate portion and which is adapted to fully or partially line the opening 2016 in the construction surface 2018, preferably closely such as within 0.25 in or 0.5 in (or more or less), or within 0-20% (or more or less) of the width of the opening 2016. The liner portion defines a vertical profile 2040 of the lighting fixture 2010 extending vertically upwardly from the periphery of the liner portion, which profile is configured to be closely received within the opening 2016 of the construction surface 2018. For example, the vertical profile 2040 can be sized and shaped to be within 0.25 in or 0.5 in (or more or less), or within about 0-20% (or more or less) of the width of the opening 2016.

The lower body assembly 2012 can include a trim element 2052, which for example can be mounted within the liner portion 2022. The trim element 2052 can include a flange 2054 extending outwardly (e.g., radially outwardly) and configured to contact a lower surface of the construction surface 18, for example to cover a gap between the liner portion 2022 and the edge of the opening 2016 in the construction surface 2016. Alternatively, the flange 2054 and/or trim element 2052 can be configured to not contact the construction surface 2018, for example, so as to provide an elevated or suspended aesthetic look to the room side, including mounting of other decorative elements.

The lighting module 2014 includes a heat sink assembly 2024 and includes a light engine assembly (not shown) which can be of a type described herein. For example, the light engine assembly can include a light emitting element (not shown), such as one or more LEDs, and can include a substrate to which the light emitting element is mounted. The light engine assembly is configured to emit light through the aperture 2020 and has an optical axis 2032 which passes through the aperture.

The heat sink assembly 2024 includes first and second heat sinks 2034, 2036 which comprise or consist of material having high thermal conductivity such as metal, or other suitable material or materials.

The second heat sink 2036 is movably mounted to the first heat sink 2034 and the second heat sink 2036 is operable to move relative to the first heat sink 2034 in a movement range between and including a retracted position and an extended position. The retracted position and/or the extended position of the second heat sink 2036 are preferably limit positions.

Preferably, the first heat sink 2034 is operable to be moved by a user between the retracted and extended positions through the aperture 2020 when the lighting fixture 2010 is installed in the construction surface 2018, for example manually and/or with a tool.

Referring to FIGS. 39-45, the second heat sink 2036 is shown in the retracted position wherein the second heat sink 2036 is entirely within the vertical profile 2040 of the lighting fixture 2010. This configuration allows the lighting fixture 2010 to be installed or removed from the opening 2016 in the construction surface 2018 at least when the second heat sink 2036 is in the retracted position.

Referring to FIGS. 46-52, the second heat sink 2036 is shown in the extended position wherein the second heat sink 2036 extends substantially beyond the vertical profile 2040 of the lighting fixture 2010. This configuration provides for additional heat dissipation capacity.

In the retracted position, the second heat sink 2036 is preferably aligned substantially parallel to the vertical (Z) axis, and in the extended position, the second heat sink 2036 is preferably aligned substantially perpendicular to the vertical (Z) axis, although other orientations are possible.

As an example, the second heat sink 2036 can be pivotally connected to the first heat sink 2034 to allow pivotal movement of the heat sink 2036 between the retracted and extended positions.

The first and second heat sinks 2034, 2036 can have cooperating thermal interfaces 2058, 2060. In the extended position, the thermal interface 2058 of the first heat sink 2034 is in thermal connection to the thermal interface 2060 of the second heat sink 2036, and, in the retracted position, the thermal interface 2058 of the first heat sink 2034 is thermally disconnected from the thermal interface 2060 of the second heat sink 2036;

For example, thermal interfaces 2058, 2060 of the first and second heat sinks 2034, 2036 can include fins 2062, 2064 which connect to form extended heat dissipation fins.

The lighting module 2014 can be configured to rotate relative to the lower body assembly 2012, for example at least 5 degrees (e.g., at least 360 degrees), about a rotation axis 2042 parallel to, or colinear with, the vertical center axis 2038 to allow for aiming of the emitted light.

The lighting fixture 2010 can include an over-rotation stop to prevent rotation of the lighting module 2014 greater than a predetermined amount relative to the lower body assembly 2012, for example more than 5-20 degrees or 360-365 degrees, or another predetermined amount of rotation.

Further, the lighting fixture 2010 preferably includes a rotation lock as described herein to selectively permit and prevent rotation of the lighting module 2014, which lock is preferably accessible through the aperture 2020.

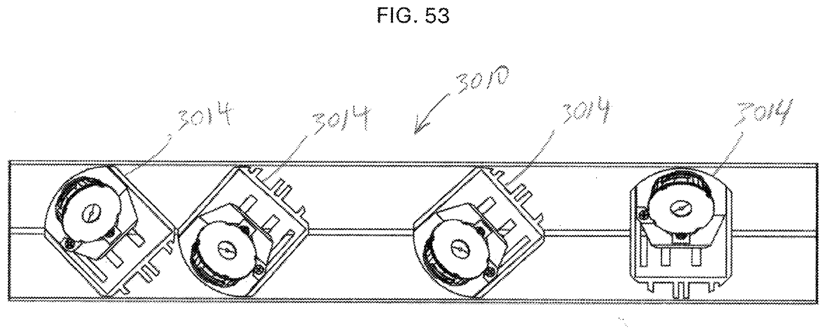

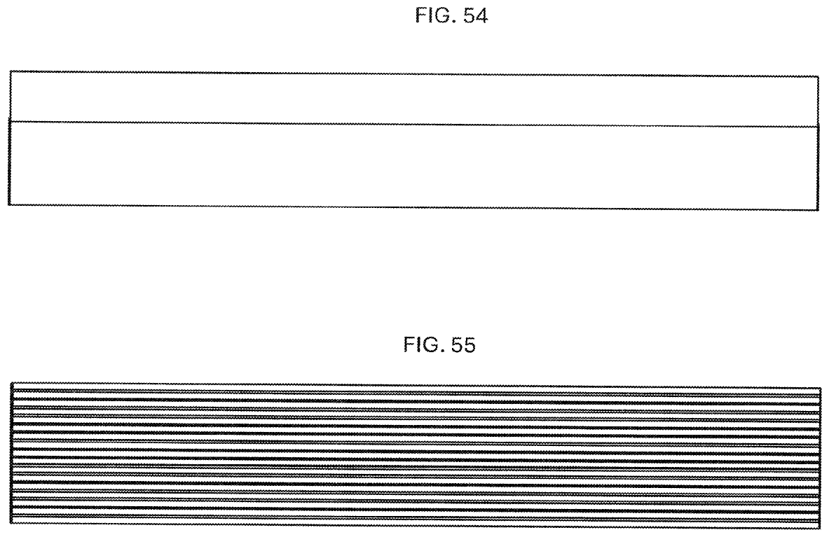

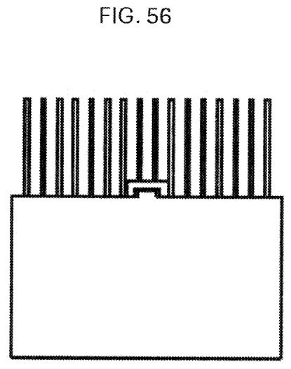

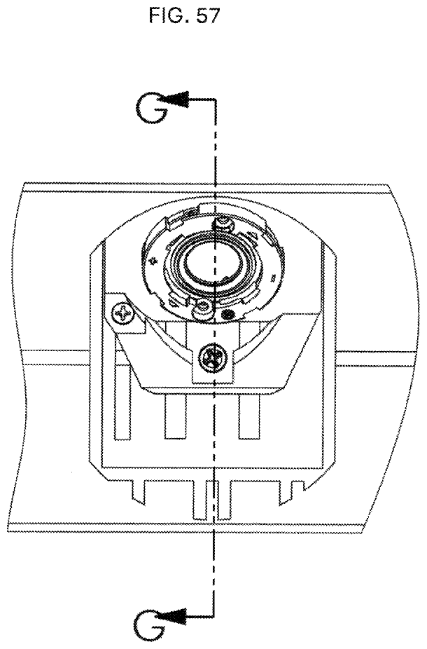

Referring to FIGS. 53-58, in a fourth embodiment, the lighting fixture 3010 has a plurality of lighting modules 3014 each having a heat sink assembly 3024 as described herein (for example with respect to the lighting modules of first and/or second embodiments). The lighting fixture 3010 includes a third heat sink 3080 to which each lighting module 3014 is preferably moveably connected.

For example, the third heatsink 3080 can be larger and able to receive a plurality of the lighting modules 3014, for example in a linear or radial pattern (or another arrangement), thus simplifying installation of the overall fixture and allowing for several adjustable light engine assemblies.

As an example, the third heat sink 3080 can be configured to permit each lighting module 3014 to move along a predetermined path along a length of thereof, such as a linear or curved path, or another shaped path. The third heat sink 3080 can include a channel which received a portion of or fastener connected to each lighting module 3014 for independent and selective movement of each lighting module 3014 along the path, relative to the third heat sink.

Preferably, the third heat sink 3080 is configured to be in thermal connection with the second heat sink 3036 of each lighting module 3014, which second heat sink 3036 is in thermal connection with the associated first heat sink 3034.

Each lighting module 3014 includes a heat sink assembly 3024 and a light engine assembly 3026.

The heat sink assembly 3024 includes first and second heat sinks 3034, 3036 which comprise or consist of material having high thermal conductivity such as metal, or other suitable material or materials.

The first heat sink 3034 is movably mounted to the second heat sink 3036 and the first heat sink 3034 is operable to move relative to the second heat sink 3036 in a movement range between and including a first position and a second position. The first position and/or the second position of the first heat sink 3034 are preferably limit positions.

Preferably, the first heat sink 3034 is operable to be moved by a user between the first and second positions through the aperture 3020 when the lighting fixture 3010 is installed, for example manually and/or with a tool.

The light engine assembly 3026 includes a light emitting element 3028, such as one or more LEDs, quantum dots, micro LEDs, laser LEDs, or other suitable light emitting components. The light engine assembly can also include a substrate 3030 to which the light emitting element 3028 is mounted. The light engine assembly 3026 is configured to emit light through the aperture 3020 and has an optical axis 3032 which passes through the aperture.

The light engine assembly 3026 is mounted to (and moves with) the first heat sink 3034.

In the first position of the first heat sink 3034, the optical axis 3032 of the light engine assembly 3026 is colinear, or substantially aligned, with the center axis 3038 such that the optical axis 3032 and substantially passing through a center of the aperture;

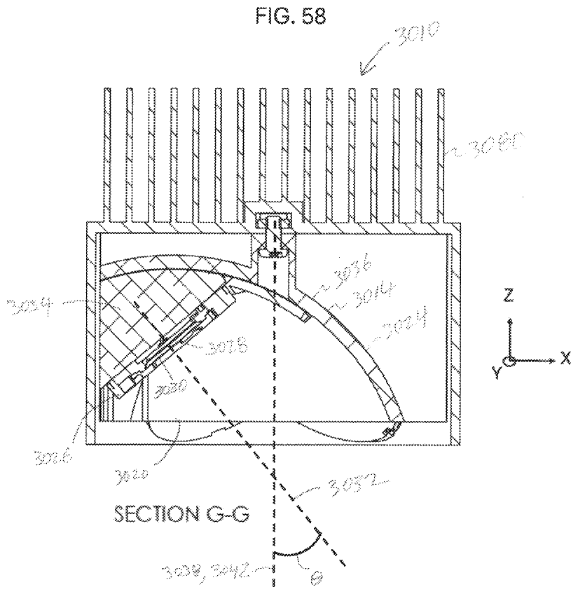

In the second position (FIGS. 57-58), the first heat sink 3034 is substantially displaced from the first position at least laterally parallel to the longitudinal (X) axis. As depicted, in the second position, the first heat sink 3034 can also be displaced vertically, parallel to the vertical (Z) axis relative to the first position.

In additional or alternatively, in the second position, the first heat sink 3034 can be tilted relative to the first position, for example about a pivot axis parallel to the lateral (Y) axis. For example, in the second position, the optical axis 3032 of the light engine assembly 3026 can be aligned at a substantially tilted angle (Θ) relative the center axis 3038.

For example, the first position can be a “down-light” or zero-tilt position, where most of the light emitted is substantially vertically downward (e.g., parallel to the center axis 3038). The second position can be a “wall-wash” position, where the light is emitted at substantial angle from vertical, and typically toward an adjacent wall or object to be illuminated.

A tilt position of the first heat sink 3034 and light engine assembly attached 3026 attached thereto is preferably adjustable relative to the second heat sink 3036 to a plurality of positions along an adjustment path (or preferably continuously to any position along the path). For example, the adjustment path can follow a curve lying on a (typically vertical) plane perpendicular to the plane of the aperture 3020 of the lighting fixture 3010 and concave toward the plane of the aperture 3020 such that, during movement of the first heat sink 3034 along the adjustment path, the optical axis 3032 of the engine assembly 3026 pivots (tilts) relative to the center axis 3038. Alternatively, the adjustment path can have a different shape or shapes such as any combination of curved, linear, angular, or stepped, or other suitable shape(s).

Each lighting module 3014 can be configured to rotate relative to the third heat sink 3080, for example at least 5 degrees (e.g., at least 360 degrees), about a rotation axis 3042 parallel to, or colinear with, the vertical center axis 3038 to allow for aiming of the emitted light.

The lighting fixture 3010 can include an over-rotation stop to prevent rotation of each lighting module 3014 greater than a predetermined amount relative to the third heat sink 3080, for example more than 5-20 degrees or 360-365 degrees, or another predetermined amount of rotation.

Further, the lighting fixture 3010 preferably includes a rotation lock as described herein to selectively permit and prevent rotation of the lighting module 3014, which lock is preferably accessible through the aperture 3020.

The following descriptions can apply to any or all embodiments. The first and second heat sinks can be comprised of thermally conductive material such as aluminum (or another suitable material having high thermal conductivity), which cooperate to dissipate heat generated by the light source, while allowing for adjustment of tilt and rotation positions of the light source. The first and/or second heatsink may utilize heat pipes or other thermal technologies and techniques to dissipate the heat generated by the light source.

The first heat sink can have a base which is thermally coupled to the light source (and/or a mount for the light source), and can have a thermal interface, which is opposite the base. For example, in the case of a Light-Emitting Diode (LED) light source, where one or a plurality of LEDs are mounted to a substrate such as a printed circuit board (PCB) or the like, the base of the first heat sink can be connected to a side of the substrate opposite the LEDs and the thermal interface is disposed on a side of the first heat sink opposite the base such that the first heat sink is operable to conduct heat from the light source to the thermal interface through a body of the first heat sink.

The first and/or second heat sinks can have heat dissipating fins disposed on an exterior surface thereof and can have a thermal interface adapted to engage and thermally couple with the thermal interface of the first heat sink. The first heat sink and light source are preferably mounted to and supported by the second heat sink such that rotation and/or translation movement of the second heat sink results in equivalent movement of the first heat sink and light source. The first and second heat sinks form a heat sink assembly which is preferably movably mounted to the lower body assembly such that the light engine assembly can translate and rotate relative to the lower body assembly and can be fixed in various positions and angles.

The thermal interface of the first heat sink is preferably in thermal contact with the thermal interface of the second heat sink (optionally with thermal tape or similar material therebetween) substantially throughout a contact area sized to the thermal needs of the specific design (for example at least about 1 cm²), to thermally couple the first and second thermal interfaces over the contact area, whereby the second heat sink is operable to remove heat from the first heat sink by thermal conduction, convection, and/or radiation through the contact area to dissipate the heat into an ambient environment through the fins.

To accommodate the curved adjustment path, the thermal interfaces of the first and second heat sinks can have complementary curved surfaces. Preferably, the thermal interface of the first heat sink is in the form of a partially cylindrical convex surface having a radius of curvature equal to that of the curved adjustment path, and the thermal interface of the second heat sink is in the form of a complementary, partially cylindrical concave surface. However, preferably, an arc length of the thermal interface of the second heat sink (as measured along the adjustment path) is substantially longer than an arc length of the thermal interface of the first heat sink. For example, the arc length of the thermal interface of the second heat sink may be 2 to 10 times greater than that of the first thermal interface to allow the first heat sink to thermally couple with the second heat sink in at least two non-overlapping positions along the adjustment path. A tilt lock is operable to selectively secure the first heat sink at a desired tilt angle.

Although the invention has been described with reference to a particular arrangement of parts, features and the like, these are not intended to exhaust all possible arrangements or features, and indeed many other modifications and variations will be ascertainable to those of skill in the art.

What is claimed:

1. A light fixture adapted to be installed in a construction surface and to emit light through an opening in the construction surface into a room, the light fixture comprising:
the light fixture having three axes consisting of a longitudinal (X) axis, a lateral (Y) axis and a vertical (Z) axis, which are mutually perpendicular;
a lower body assembly operable to mount the light fixture to the construction surface, and the lower body assembly having an aperture;
a center axis parallel to the vertical axis (Z), and the center axis passing through a center of the aperture at a perpendicular angle;
a lighting module connected to the lower body assembly, the lighting module including a heat sink assembly and a light engine assembly, and the light engine assembly including a light emitting element;
the heat sink assembly including first and second heat sinks;
the first heat sink being movably mounted to the second heat sink;
the first heat sink being operable to move relative the second heat sink in a movement range including a first position and a second position;
the first heat sink maintaining a thermal connection pressure with the second heat sink throughout the movement range;
the light engine assembly being mounted to the first heat sink;
the light engine assembly having an optical axis passing through the aperture and being configured to emit light through the aperture;
in the first position of the first heat sink, the optical axis of the light engine assembly being substantially aligned with the center axis and substantially passing through a center of the aperture;
in the second position, the first heat sink being substantially displaced from the first position at least laterally parallel to the longitudinal (X) axis;
the light engine assembly being operable to emit light through the aperture throughout the movement range; and
the first and second positions being limit positions.

2. The light fixture as in claim 1, further comprising:
the lower body assembly having a liner portion configured to at least partially line the opening in the construction surface and the liner portion defining a vertical profile of the light fixture parallel to the vertical (Z) axis; and
in the first and second positions, the first heat sink being entirely within the vertical profile of the light fixture;
whereby the light fixture may be installed through the opening in the construction surface when the first heat sink is in any position in the movement range.

3. The light fixture as in claim 1, wherein:
in the second position of the first heat sink, the optical axis of the light engine assembly is aligned at a substantially tilted angle relative center axis.

4. The light fixture as in claim 1, wherein:
the lighting module is operable to rotate relative to the lower body assembly about a rotation axis parallel to the center axis.

5. The light fixture as in claim 1, wherein:
the first heat sink is operable to be moved between the first and second positions through the aperture when the light fixture is installed in the construction surface.

6. A light fixture adapted to be installed in a construction surface and to emit light through an opening in the construction surface into a room, the light fixture comprising:
the light fixture having three axes consisting of a longitudinal (X) axis, a lateral (Y) axis and a vertical (Z) axis, which are mutually perpendicular;
a lower body assembly operable to mount the light fixture to the construction surface, and the lower body assembly having an aperture;
a center axis parallel to the vertical axis (Z), and the center axis passing through a center of the aperture at a perpendicular angle;
the lower body assembly having a liner portion configured to at least partially line the opening in the construction surface and the liner portion defining a vertical profile of the light fixture parallel to the vertical (Z) axis;
a lighting module connected to the lower body assembly, the lighting module including a heat sink assembly and a light engine assembly, and the light engine assembly including a light emitting element;
the heat sink assembly including first and second heat sinks;
the first heat sink being movably mounted to the second heat sink;
the first heat sink being operable to move relative the second heat sink in a movement range including a first position and a second position;
the first heat sink maintaining a thermal connection pressure with the second heat sink throughout the movement range;
the light engine assembly being mounted to the first heat sink;
the light engine assembly having an optical axis passing through the aperture and being configured to emit light through the aperture;
in the first position of the first heat sink, the optical axis of the light engine assembly being substantially aligned with the center axis and substantially passing through a center of the aperture;
in the second position, the first heat sink being substantially displaced from the first position at least laterally parallel to the longitudinal (X) axis;
the light engine assembly being operable to emit light through the aperture throughout the movement range;
the first and second positions being limit positions.

7. The light fixture as in claim 6, further comprising:
the lower body assembly having a liner portion configured to at least partially line the opening in the construction surface and the liner portion defining a vertical profile of the light fixture parallel to the vertical (Z) axis;
in the first position, the first heat sink being entirely within the vertical profile of the light fixture; and
in the second position, the first heat sink extending substantially outside the vertical profile of the light fixture;
whereby the light fixture may be installed through the opening in the construction surface when the first heat sink is in the first position.

8. The light fixture as in claim 6, wherein:
the movement range of the first heat sink includes a first range including the first position and an intermediate position between the first and second positions; and
in the first range, the first heat sink is entirely within the vertical profile of the light fixture;
whereby the light fixture may be installed through the opening in the construction surface when the first heat sink is in any position in the first range.

9. The light fixture as in claim 6, wherein:
in the second position of the first heat sink, the light emitting element is entirely within the vertical profile of the light fixture.

10. The light fixture as in claim 6, wherein:
in the second position of the first heat sink, the optical axis of the light engine assembly is aligned at a substantially tilted angle relative the center axis.

11. The light fixture as in claim 6, wherein:
the lighting module is operable to rotate relative to the lower body assembly about a rotation axis parallel to the center axis.

12. The light fixture as in claim 6, wherein:
the first heat sink is operable to be moved between the first and second positions through the aperture when the light fixture is installed in the construction surface.

13. A light fixture adapted to be installed in a construction surface and to emit light through an opening in the construction surface into a room, the light fixture comprising:
the light fixture having three axes consisting of a longitudinal (X) axis, a lateral (Y) axis and a vertical (Z) axis, which are mutually perpendicular;
a lower body assembly operable to mount the light fixture to the construction surface, and the lower body assembly having an aperture;
a center axis parallel to the vertical axis (Z), the center axis passing through a center of the aperture at a perpendicular angle;
the lower body assembly having a liner configured to at least partially line the opening in the construction surface and the liner defining a vertical profile of the light fixture parallel to the vertical (Z) axis;
a lighting module connected to the lower body assembly, the lighting module including a heat sink assembly and a light engine assembly, and the light engine assembly including a light emitting element;
the heat sink assembly including first and second heat sinks;
the light engine assembly having an optical axis passing through the aperture and being configured to emit light through the aperture;
the second heat sink being movably mounted to the first heat sink and being movable relative to the first heat sink between a retracted position and an extended position;
the retracted and extended positions being limit positions;
in the extended position, a thermal interface of the first heat sink being in thermal connection to a thermal interface of the second heat sink; and
in the retracted position, the thermal interface of the first heat sink being thermally disconnected from the thermal interface of the second heat sink.

14. The light fixture as in claim 13, further comprising:
the lower body assembly having a liner configured to at least partially line the opening in the construction surface and the liner defining a vertical profile of the light fixture parallel to the vertical (Z) axis;
in the extended position, the second heat sink extending substantially outside the vertical profile of the light fixture; and
in the retracted position the second heat sink and the second heat sink being entirely within the vertical profile of the light fixture;
whereby the light fixture may be installed through the opening in the construction surface when the second heat sink is in the retracted position.

15. The light fixture as in claim 11, wherein:
the second heat sink is operable to be moved between the retracted and extended positions through the aperture when the light fixture is installed in the construction surface.

16. The light fixture as in claim 11, wherein:
the second heat sink is pivotally connected to the first heat sink.

17. The light fixture as in claim 13, wherein:
in the retracted position, the second heat sink is aligned substantially parallel to the vertical (Z) axis; and
in the extended position, the second heat sink is aligned substantially perpendicular to the vertical (Z) axis.
